(19) United States
(12) Patent Application Publication
(10) Pub. No.: US 2008/0037533 A1
(43) Pub. Date: Feb. 14, 2008

(54) Methods, systems, and computer program products for associating independent legs of a call in a telecommunications network

(75) Inventors: Allen Wah, Plano, TX (US); Phil Chiu, Plano, TX (US)

Correspondence Address: JENKINS, WILSON, TAYLOR & HUNT, P. A., 3100 TOWER BLVD., Suite 1200, DURHAM, NC, 27707, US

(73) Assignee: Santera Systems, Inc.

(21) Appl. No.: 11/544,455

(22) Filed: Oct. 6, 2006

Related U.S. Application Data
(60) Provisional application No. 60/837,597, filed on Aug. 11, 2006.

(51) Int. Cl. H04L 12/56

(52) U.S. Cl. 370/389; 370/401

(57) ABSTRACT

Methods, systems, and computer program products for making call association across elements of a converged network are disclosed. A method is disclosed herein for associating independent legs of a call at a network node. According to one method, a first signaling message for setting up a first call leg is sent from a network node, the first signaling message including an identifier associated with the first call leg; a second signaling message for setting up a second call leg is received by the network node, the second signaling message including an identifier associated with the second call leg; the identifiers associated with the first and second call legs are compared, and if the values are found to have a predetermined relationship to each other, the first and second call legs are associated with each other.

### RELATED APPLICATIONS

This application claims the benefit of a U.S. Provisional Patent Application Ser. No. 60/837,597, filed Aug. 11, 2006; the disclosure of which is incorporated herein by reference in its entirety.

### TECHNICAL FIELD

The subject matter described herein relates to methods, systems, and computer program products for operation of a converged network. More particularly, the subject matter described herein relates to methods, systems, and computer program products for associating independent legs of a call in a telecommunications network.

### BACKGROUND

As telecommunications networks have evolved from being circuit-based to using a packet-based architecture, the concept of a call has changed from a continuous circuit between point A and point B to packets of digitized voice data traveling across a network, using any path available between point A and point B. This concept has been extended to send any type of data, not just digitized voice data, across the telecommunications network, resulting in modern converged networks which allow telecommunications service providers to offer multimedia streaming, web-browsing, and other data-oriented services in addition to traditional telephone service to their customers.

Typical converged networks, however, are not purely packet-based, but are an amalgam of various types of networks, including public switched telephone networks (PSTN), mobile networks, wi-fi networks, and the Internet. Usually, some form of gateway devices are required to provide an interface between the PSTN components and the packet-based components of a converged network and to convert data from one format and protocol into another. For example, PSTN networks use time division multiplexing (TDM), in which the caller's voice is digitized and assigned to a time slot in a frame of data traveling between nodes in the PSTN network, while packet networks use transmission control protocol (TCP) or user-datagram protocol (UDP) to transport packets of data such as digitized voice. Also, in PSTN networks, the bearer channel, which carries voice or data traffic, and the signaling channel, which is used by nodes in the PSTN network to negotiate the route of the bearer channel through the network, typically use physically separate networks. In contrast, while packet-based networks may maintain the concept of distinct signaling and bearer messages, both types of messages typically travel along the same physical network. Therefore, converged networks typically require two distinct types of gateway devices or gateway functions to connect the PSTN and packet-based networks: one for the bearer channel and another for the signaling channel.

The bearer channel interface between traditional PSTN networks and packet-based networks, such as an Internet protocol multimedia subsystem (IMS) network, may be provided by a media gateway (MGW). The MGW may convert data between TDM format and packet format. A physical interface on the MGW may be referred to as a termination point. The signaling channel interface between traditional PSTN networks and packet-based networks may be provided by a media gateway controller (MGC). The MGC may convert between signaling system #7 (SS7) used by PSTNs and session initiation protocol (SIP) used by IMS and other packet-based networks. The MGC typically controls one or more media gateways. A MGC that is used in combination with one or more MGWs for voice over Internet protocol (VoIP) is commonly called a softswitch, because the MGC no longer contains switch hardware, now located in the MGW.

In packet-based communication, there is no tight correlation between the bearer path (the path taken by the call) and the signaling path (the path used for communicating between nodes in a network in order to properly route the call packets from source to destination). Nor is there a requirement that the bearer path and signaling path be created together and dismantled together; a signaling path may stay up for a leg of a call while the media path of the leg of the call is taken down. For example, someone calling an automated reservation system, such as those used for booking airline flight reservations, might connect first to an automated voice menu program running on a server in one location, then connect to a human operator in another location. In such a situation, the signaling path to the voice menu program server may continue to operate (to exert application level call control and other functionality such as billing, for example) even though the bearer path to the voice menu program server has been dismantled—e.g., when the caller is switched from talking to the voice menu program to talking with a human operator. One benefit of this arrangement is that the voice menu program is now available for use by the next person who calls the airline flight reservation number. Another benefit of the use of packet-based communication is that the caller may be transparently rerouted from the voice menu server to a human operator without the need for the caller to hang up from the menu server and dial again to reach the human operator. Other benefits of packet-based communication include the ability to add additional callees (e.g., conference calling, three-way calling, etc.), and the ability to associate other data with the call, such as caller ID.

In contrast to circuit-based communication, where a single logical end-to-end circuit is dedicated to carrying the call, packet-based communication has adopted a generic call control model, referred to as a “half-call” model, in which a call is conceptually divided into two half-calls: the originating (ingress) portion, corresponding to the caller's connection from the PSTN to the packet network, and the terminating (egress) portion, corresponding to the callee's connection from the packet network to the PSTN.

As used herein, the term “call leg” refers to a bidirectional bearer path through a network processing node. A call leg is roughly analogous to a half-call in that it corresponds to an ingress or egress portion of a call. As used herein, the term call leg is not analogous to a SIP dialog; a SIP dialog describes a logical connection between two endpoints of a path, while a call leg describes a data path through a network processing node such as a media gateway.

As used herein, the term “context” refers to the logical association of two or more terminal points with each other to indicate the physical interfaces and resources a particular call is occupying in a network processing node. For example, a call context may describe a call, through a MGW, that uses the MGW's TDM channel interface 5 to connect to a PSTN network, and uses the MGW's Ethernet interface 12 to connect to a packet interface.

As used herein, the term “call instance” refers to an object created in a network processing node, such as a media gateway controller, to represent a call. A call instance may maintain information about the call such as the call's context and the IP addresses and ports of the ingress and egress media gateways through which the call travels. Thus, a call instance may maintain more information than is associated with the half-call model.

One consequence of using the half-call model is that due to the loose correlation between the two legs of a call, the telecommunications network control system may be unable to identify and rectify situations where network resources are inefficiently used. A non-trivial example is the so-called “hairpin” situation—a loop condition where a connection originates and terminates at the same node. A hairpin may not be created directly, but may be an artifact resulting from a process of several steps, as described in the example below.

FIG. 1A illustrates the first step in a hairpin scenario, using the example of a caller making a flight reservation described above. Referring to FIG. 1A, caller 100 on a public switched telephone network PSTN 102 dials the telephone number of an airline flight reservation system, an automated voice menu system which is provided by a SIP application server SAS 104 within packet network 106. Based upon the telephone number, SS7 signaling messages may be sent to media gateway controller MGC 108, which may use media gateway control protocol (MGCP) messages to control media gateway MGW 110 to establish a bearer path between caller 100 and MGW 110. MGC 108 may establish call leg L1 through MGW 110, and send a SIP INVITE request to SAS 104 to create a bearer path from MGW 110 to SAS 104 through packet network 106. Once call leg L1 connects these two bearer paths, caller 100 may use the voice menu system.

FIG. 1 B illustrates the next step in the hairpin scenario. If for example caller 100 selects a voice menu option to transfer his call to another person, callee 112, SAS 104 will initiate the connection from SAS 104 to callee 112, which includes sending a request to MGC 108 to create a bearer path from SAS 104 through packet network 106 to MGW 110. MGC 108 may establish call leg L2 through MGW 110 and create a bearer path from MGW 110 through PSTN 102 to callee 112. In this way, a loop is created from MGW 110 to SAS 104 and back again, through call legs L1 and L2.

FIG. 1 C illustrates the final step in the hairpin scenario. Because SAS 104 is no longer needed in the path from caller 100 to callee 112, it will issue a SIP RE-INVITE command to MGC 108, instructing it to connect call leg L1 to call leg L2, creating a hairpin condition at MGW 110. This type of hairpin, created as a result of a connection to and later disconnection from a node, is referred to as a node hairpin. Although functional, the hairpin so created is an inefficient use of network resources. This is shown in more detail in FIG. 2A through FIG. 2C.

FIG. 2A illustrates call leg L1 shown in FIG. 1A in more detail. Referring to FIG. 2A, digitized voice data from caller 100 is part of TDM data 200 transported across PSTN 102 to MGW 110 to be processed. Call leg L1 is the data path through MGW 110. Call data from TDM channel interface C1 202 is routed through a switching matrix 204 to an available voice server 206. The function of voice server 206 is to convert data between TDM format and packet format. Thus, it is common for voice server 206 to be a digital signal processor (DSP) or other, typically expensive, hardware. Packet data produced by voice server 206 is sent to a packet matrix 208, which routes the packet data to an available Ethernet interface E1 210. The call is routed through El 210 and across packet network 106 (not shown) to SAS 104, allowing caller 100 to talk to the voice menu system 212.

FIG. 2B illustrates the call legs L1 and L2 shown in FIG. 1B in more detail. Referring to FIG. 2B, caller 100 has for example selected a voice menu option to connect to another party, callee 112. In response, SAS 104 has connected caller 100 with callee 112 by establishing a new call leg L2 through MGW 110 via the data path shown through Ethernet interface E2 214, voice server 216 and TDM channel interface C2 218.

A MGW typically has multiple physical interfaces through which bearer traffic may flow. In FIG. 2A, four termination points are shown: the TDM channel interfaces C1 202 and C2 218, and the Ethernet interfaces E1 210 and E2 214. In the example shown in FIG. 2B, a first call context will associate terminal point C1 202 with terminal point E1 210, and a second call contextwill associate terminal point C2 218 with terminal point E2 214.

FIG. 2C illustrates the condition shown in FIG. 1C in more detail. Referring to FIG. 2C, SAS 104 has issued a SIP RE-INVITE command to MGC 108 (not shown), creating a logical connection between caller 100 and callee 112, through call legs L1 and L2. Note that the first and second contexts as described above for FIG. 2B did not change and still exist in FIG. 2C. In FIG. 2C it can be seen that this hairpin condition consumes significant resources within MGW 110, including two TDM channel interfaces, two voice servers, two Ethernet interfaces, and internal switching channels within the switching matrix and packet matrix modules. If, from this point on, caller 100 has no need to access any service or feature within packet network 106, there may be no need to route the call through the DSP or packet resources of MGW 110.

Currently there are no means by which an entity in the network can recognize that the first and second legs of a call are associated with each other so that it may free the packet and DSP resources in use by the two call legs and make the released resources available for the next caller.

Accordingly, in light of these disadvantages associated with the occurrence of hairpin conditions within a converged network, there exists a need for a way to associate multiple legs of a call across elements of a converged network.

### SUMMARY

According to one aspect, the subject matter described herein includes a method for associating independent legs of a call, by sending from a network node a first signaling message to set up a first call leg, the first signaling message containing an identifier associated with the first call leg; receiving at the network node a second signaling message to set up a second call leg, the second signaling message containing an identifier associated with the second call leg; and comparing the identifiers associated with the first and second call legs, and if the identifiers have a predetermined relationship with respect to each other, associating the first and second call legs with each other.

According to another aspect, the subject matter described herein includes a system for associating independent legs of a call, including a network node adapted to send a first signaling message for setting up a first call leg, the first signaling message containing an identifier associated with the first call leg, the network node adapted also to receive a second signaling message for setting up a second call leg, the second signaling message containing an identifier associated with the second call leg, and a call association module for determining whether the identifiers associated with the first and second call legs have a predetermined relationship with respect to each other, and if so, associating the first and second call legs together.

According to yet another aspect, the subject matter described herein includes a call association initiating network element, including a signaling module for sending and receiving signaling messages containing identifiers respectively associated with independent call legs, and a call association module for analyzing the identifiers to determine whether any two or more identifiers have a predetermined relationship with respect to each other, and if so, associating with each other the call legs corresponding to the identifiers which have a predetermined relationship with respect to each other.

The subject matter described herein for managing an IMS network may be implemented in hardware, software, firmware, or any combination thereof. As such, the terms “function” or “module” as used herein refer to hardware, software, and/or firmware for implementing the feature being described. In one exemplary implementation, the subject matter described herein may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1A is a block diagram illustrating an exemplary converged network in which a caller is communicating with a SIP application server;

FIG. 1B is a block diagram illustrating an exemplary converged network in which a SIP application server has redirected a caller to a callee;

FIG. 1C is a block diagram illustrating an exemplary converged network in which a SIP application server has dismantled call legs between itself and a media gateway controller, creating a hairpin condition at the media gateway controller;

FIG. 2A is a block diagram illustrating the network shown in FIG. 1A, showing the data paths through a media gateway controller in detail;

FIG. 2B is a block diagram illustrating the network shown in FIG. 1B, showing the data paths through a media gateway controller in detail;

FIG. 2C is a block diagram illustrating the network shown in FIG. 1C, showing the data paths through a media gateway controller in detail;

FIG. 3A is a block diagram illustrating an exemplary packet network including a node that may be used to implement the subject matter herein;

FIG. 3B is a flow chart illustrating an exemplary process for making a call association across elements of a converged network according to an embodiment of the subject matter described herein;

FIG. 4 is a block diagram illustrating the exchange of messages between call instances as part of the call association process in accordance with an embodiment of the subject matter described herein; and

FIG. 5 is a block diagram illustrating an exemplary system implementing call association within a call association initiating network element in accordance with an embodiment of the subject matter described herein.

### DETAILED DESCRIPTION

In accordance with the subject matter described herein, methods, systems, and computer program products are provided for making call association across elements of a converged network. Call association may be effectuated by encoding a call association (CA) data element in a signaling message, such as a SIP request message. The CA data element may function by uniquely identifying the call itself, by identifying the originating and terminating network nodes of the call, or both. The originating and terminating network nodes of a call may be, for example, the media gateway associated with the caller and the media gateway associated with the cal lee, respectively. Alternatively, they may, for example, refer to the media gateway associated with the caller and a SIP application server, respectively.

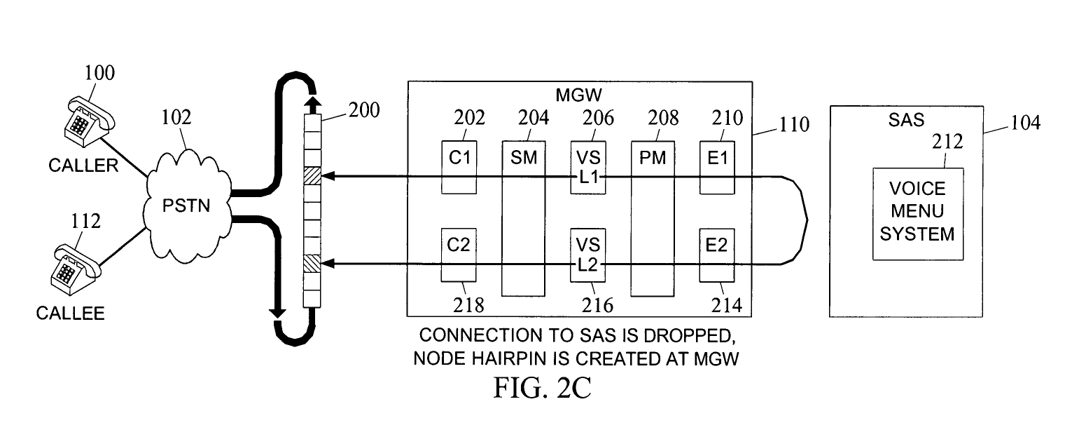

FIG. 3A is a block diagram of network node N 300 connected to packet network 106. In FIG. 3A, network node N 300 includes both a signaling function for processing signaling data and a bearer function for processing bearer data in the same node, as in the case of a softswitch. However, it should be noted that the signaling and bearer functions may reside in separate but associated network nodes, such as in a MGC and MGW, respectively, or in a media application server (MAS) and a SIP application server (SAS), respectively. In FIG. 3A, two independent call legs L1 and L2 are established within network node N 300 by means of signaling messages M1 and M2 sent and received by N 300. A signaling message includes an identifier associated with the call leg established in response to the signaling message. In one exemplary implementation, the identifier may include a value created for the purpose of call association and contained in a loose routing header field of a SIP INVITE message. The loose routing headerfield provides the flexibility to encode custom information without affecting standard network behavior. Other fields of SIP request messages are also possible candidates for encoding the CA data. The SIP loose routing header field, as specified in IETF FRC 3261, the disclosure of which is herein incorporated by reference in its entirety, is used to indicate that a SIP proxy follows more flexible procedures for processing of the route header field. These procedures separate the destination of the request (present in the Request-URI) from the set of proxies that need to be visited along the way (present in the route header field). The encoded call association data preserve the originally intended loose routing behavior. In another exemplary implementation, the identifier may include information contained in the signaling message, such as the origination and termination network addresses of the bearer path created in response to the signaling message, where the network addresses of the bearer path may be derived for example from information contained in SIP or session description protocol (SDP) message components. A call association module 302 compares the values of the identifiers associated with the call legs to determine whether the call legs should be associated with each other. In FIG. 3A, call association module 302 is a component of network node N 300. It will be understood that call association module 302 may reside in a location other than within network node N 300 without departing from the scope of the invention, and that the foregoing description is for the purpose of illustration only and not for the purpose of limitation.

FIG. 3B is a flow chart illustrating an exemplary process for making a call association across elements of a converged network in accordance with an embodiment of the subject matter described herein. Referring to FIG. 3B, in step 304, network node N 300 may send a signaling message M1 for setting up call leg L1. Message M1 may include an identifier ID1 associated with call leg L1. Call association module 302 may associate the value of identifier ID1 with call leg L1.

In a node hairpin situation, signaling message M1 may be sent to a second signaling node located in packet network 106; the second signaling node copies identifier ID1 into a signaling message M2 for setting up call leg L2, which is sent to network node N 300.

In a network hairpin situation, signaling message M1 may enter packet network 106, be routed through the network, and eventually emerge as message M2—still containing identifier ID1.

In step 306, network node N 300 receives signaling message M2 for setting up call leg L2. Call association module 302 may associate the value of identifier ID1 with call leg L2. At this point in this example there are two call legs, each representing an ingress or egress portion of a call, and possibly representing the ingress and egress portion of the same call.

In step 308, call association module 302 compares the identifiers associated with call legs L1 and L2. The comparison may be triggered by receipt of message M2 by N 300. The comparison may analyze the identifiers associated with the call legs by looking for a predetermined relationship with respect to each other. For example, if the identifier is a call-association value associated with a call leg, the comparison may involve looking for an exact match between identifiers; if the identifier is a combination of the origination and termination addresses of the bearer nodes associated with a call leg, the comparison may involve comparing the origination address of one call leg with the termination address of another, and vice versa. Other predetermined relationships may be used.

In step 310, if the identifiers are found to have a predetermined relationship with respect to each other, then the flow moves to step 312, in which call legs L1 and L2 are associated with each other. The association may be in the form of an entry in a table or database, or in the form of a storage location in memory or other storage device. If the identifiers are not found to have a predetermined relationship with respect to each other, no association is made. In FIG. 3B, the predetermined relationship checked for is equivalence; if the identifiers are equal, the call legs will be associated with each other.

The details of associating two call legs together may depend upon the specific architecture of the call association module 302. For example, a call manager may keep track of all live calls, perform a search using each identifier associated with a call leg, and make an association between call legs whose identifier matches or otherwise has a predetermined relationship. Alternatively, each call leg may be associated with call instances, which communicate with each other to make associations between call legs.

Turning now to a detailed description of the format of messages used, an exemplary SIP loose routing header including call association data suitable for use with embodiments of the subject matter described herein is shown below:

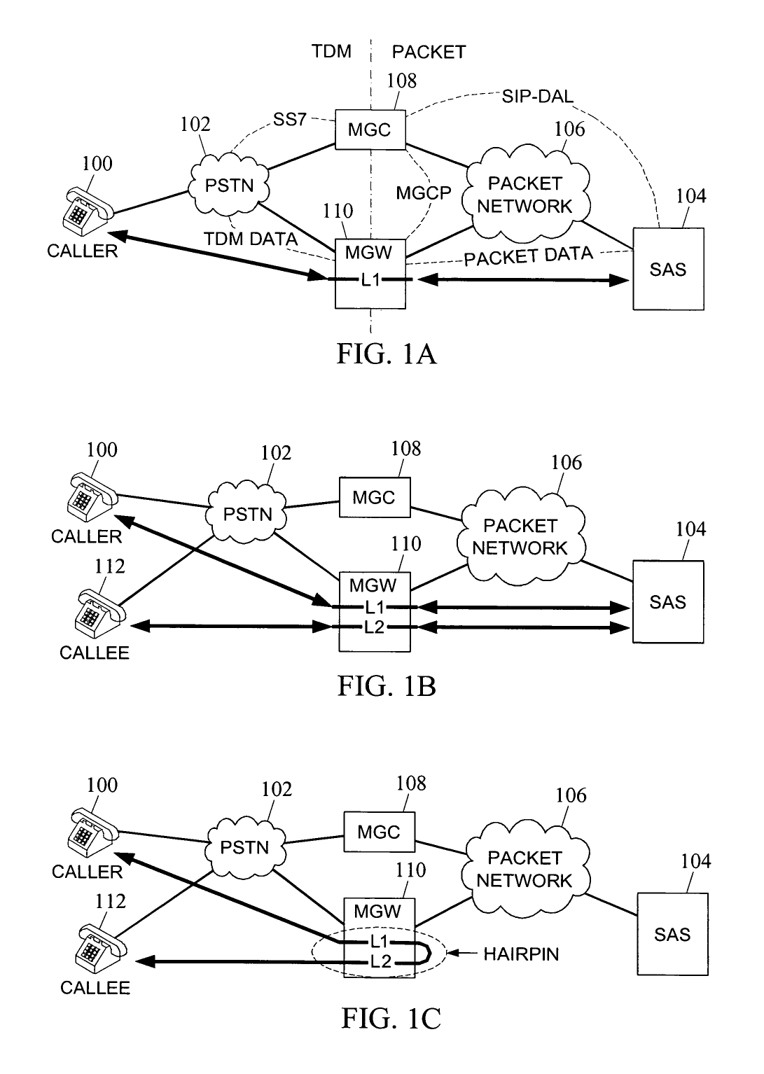

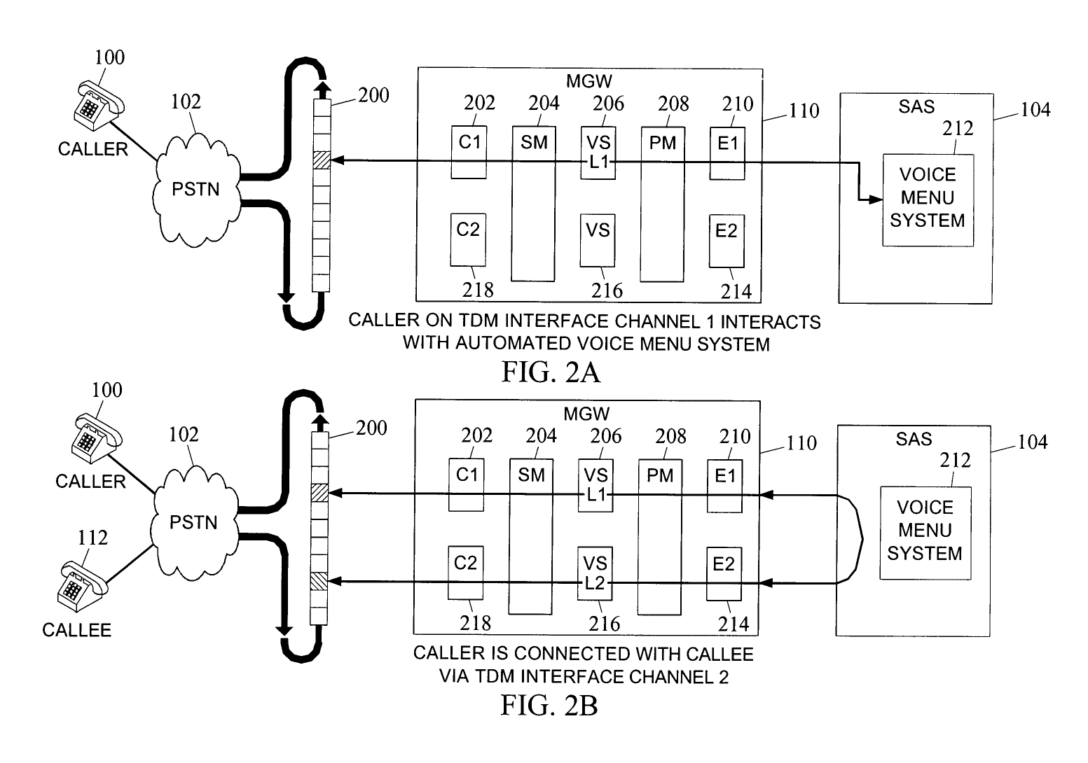

Route:<sip: {CAID}{LC}{GID}-CA@{SIPaddr};lr>

where {CAID} is an 8-digit hexadecimal call association identifier, {LC} is a 2-digit decimal loop counter, {GID} is a 2-digit decimal preferred media gateway identifier, and {SIPaddr} is the IP address of the SIP signaling interface of the MGC in dotted format (x.x.x.x). The string “-CA” is an example of a marker used to identify this header as one containing call association information. For illustrative purposes, we consider a message sent from MGC 108 to SAS 104 in FIG. 1A.

Call Association Identifier CAID uniquely identifies a call being generated or processed by a node, and is saved in the dialog for that call leg. This identifier allows MGC 108 to determine which call instance sent out this call to SAS 104.

Loop Counter LC is used to indicate the number of times that the call has entered into the terminating node, which in this example is SAS 104. It is first set to “1”, and is incremented by 1 each time the call is routed back to SAS 104, to prevent MGC 108 from routing the call an unlimited number of times to SAS 104.

Finally, the Preferred Media Gateway number GID is used to indicate which media gateway, of the potentially many media gateways that are controlled by MGC 108, will be used to processes the real time protocol (RTP) stream for this call.

It will be appreciated that both the individual components of the call association data, as well as the call association data taken as a whole, may take many possible formats, and that the exemplary format described here is for illustrative purposes only and is not intended to limit the scope of the invention. For example, CAID need not be limited 8 digits, nor to hexadecimal digits only, but could be a combination of letters, numbers, punctuation, and so on. The formats of LC, GID, and the marker used to identify the header as one containing call association information are similarly unconstrained. The format of SIPaddr could be numeric (e.g., “192.168.1.17”) or other (e.g., “mgc3.area15.pop10”), for example.

To allow the possibility of elimination of a hairpin condition, it is desirable to have both legs of a call go through the same media gateway, such as is shown in FIG. 1 C, where call legs L1 and L2 both go through MGW 110. If call leg L2 had been established through a media gateway other than MGW 110, there is no hairpin condition through a single media gateway.

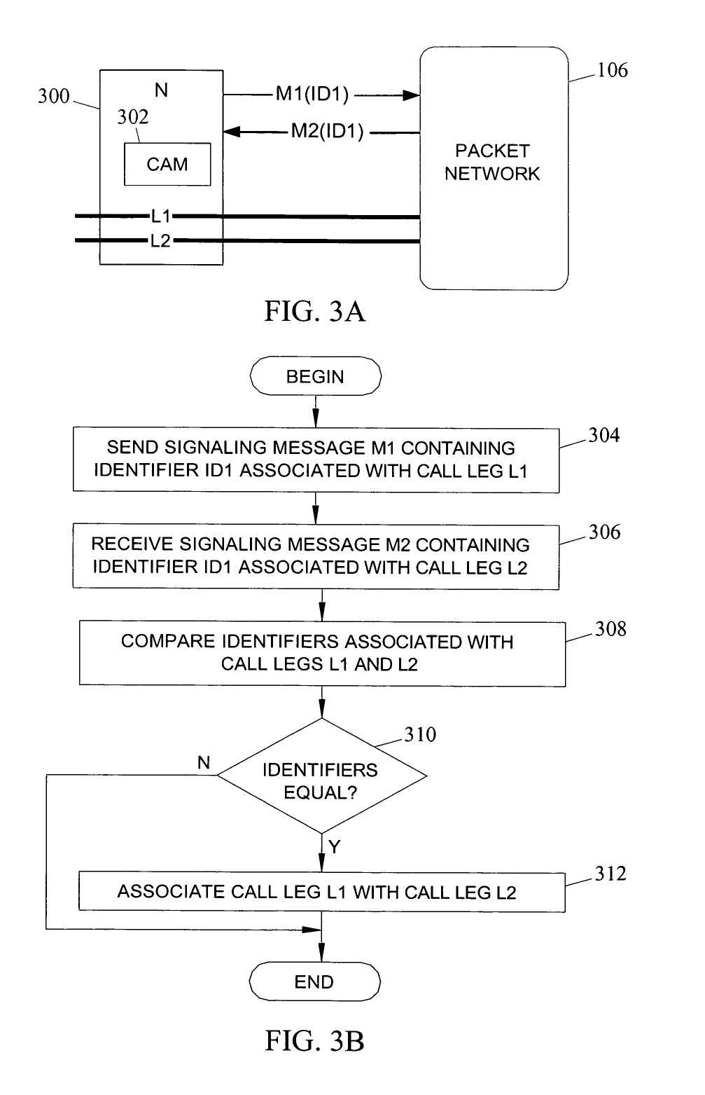

FIG. 4 is a block diagram illustrating an exemplary process for exchanging messages between call instances as part of the call association process in accordance with an embodiment of the subject matter described herein. In this embodiment, a call processing instance is created for each leg. Referring to FIG. 4, MGC 108 receives a SETUP message 1 from the PSTN (not shown), and creates call instance #1 400, which sends to SAS 104 a SIP INVITE message 2. The SIP message 2 includes a loose routing header, which contains call association data (CAID, LC, GID, and the IP address of the SIP interface of MGC 108.) SAS 104 sends to MGC 108 a SIP INVITE message 3 with a loose routing header containing the call association data which was copied from SIP message 2, and MGC 108 creates call instance #2 402. Call instance #2 402 uses the call association data from the loose routing header to identify call instance #1 400, and makes an association with call instance #1 400 by sending to call instance #1 400 an internal communication message, ATTACH message 4, which includes the IP and port address of its RTP stream with SAS 104. Call instance #1 400 sends back to call instance #2 402 an internal communication message, RESPONSE message 5, which includes the IP and port address of its RTP stream with SAS 104. Call instance #2 402 then sends SETUP message 6 to the PSTN.

For a distributed architecture, the two call instances may exist on different media gateway controller nodes. In this scenario the two call instances may communicate with each other using an internal call manager message protocol (CCMP). This call association mechanism allows the media gateway controller to associate multiple call instances of a single call when this call is routed out to an external application server and looped back to the media gateway controller again.

It may be unnecessary, or prohibitively expensive, to attempt to initiate call association for every call. A system may use a variety of mechanisms to limit call association to a selected subset of calls. According to one embodiment, call association is performed based on trunk group, which is provisioned when call association is activated. Referring to the network in FIG. 1 A, call association may for example be performed only for calls that are routed to an external application server such as SAS 104, which is connected to MGC 108 using the SIP-DAL trunk. The trunk may be marked with ‘Call Association’ feature enabled. Other mechanisms include marking a particular call type, service type, or combination as “CA-enabled” to trigger a call association mechanism.

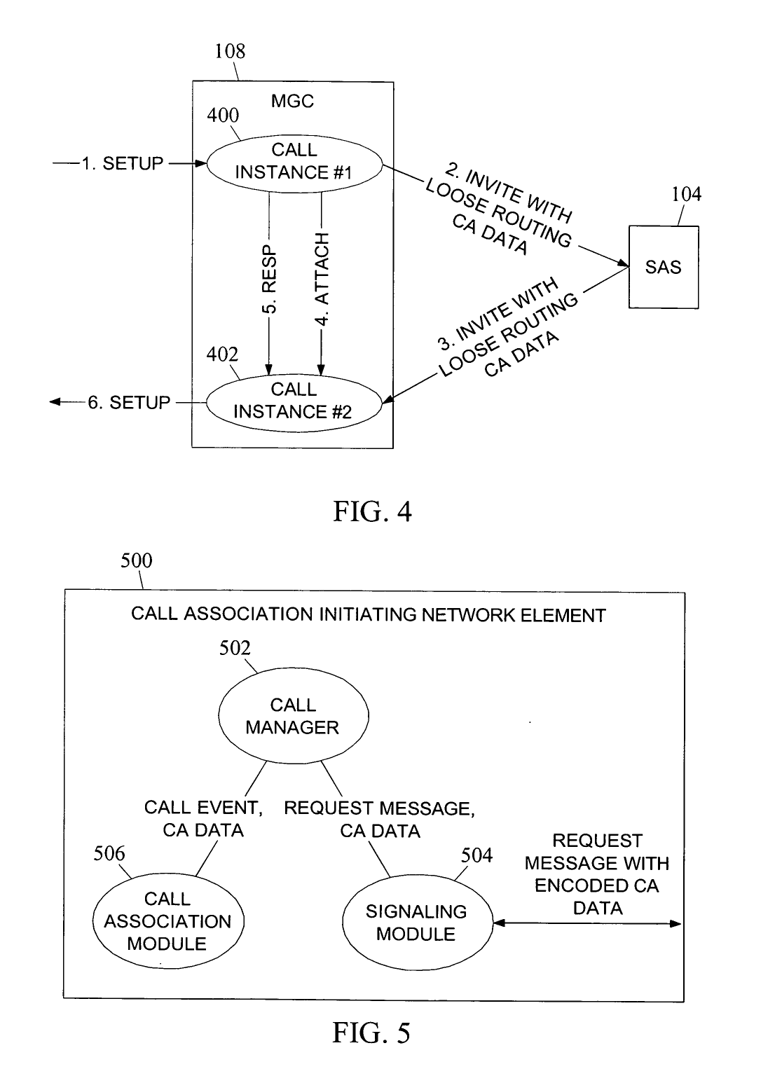

A call association initiating (CAI) network element may be for example a media gateway controller, a media gateway, or combination of the two. It may also be an application server or some other network element that has basic call association capability. The call association capability may be combined or separated into different physical or logical system modules. An example of one such implementation is shown in FIG. 5 and described below.

FIG. 5 is a block diagram illustrating an exemplary system implementing call association within a call association initiating network element in accordance with an embodiment of the subject matter described herein. Referring to FIG. 5, call association initiating network element CAI 500 includes a call manager 502, a signaling module 504, and a call association module 506.

The responsibilities of call manager 502 may include initiating call association, managing call instances, and initiating a search for a call leg based on the value of an identifier extracted from an incoming call setup message. In one implementation, a call processing instance may be created for each leg of a call, and multiple call instances may be created for multiple legs of a call. Call manager 502 may be responsible for monitoring the event or condition that will trigger the call association capability and associated operations.

The responsibilities of signaling module 504 may include creating an outgoing call setup message for setting up a call leg, encoding into the outgoing message an identifier associated with the call leg, and sending the outgoing message; and receiving an incoming call setup message for setting up a call leg and extracting from the incoming message an identifier associated with the call leg.

The responsibilities of call association module 506 may include creating the identifier associated with a call leg that is to be encoded in an outgoing call setup message, interpreting the identifier associated with a call leg element extracted from an incoming call setup message, and performing a search for a call leg based on the value of the identifier extracted from the incoming call setup message.

It will be understood that various details of the invention may be changed without departing from the scope of the invention. Furthermore, the foregoing description is for the purpose of illustration only, and not for the purpose of limitation.

What is claimed is:

1. A method for associating independent legs of a call, the method comprising:
(a) sending a first signaling message from a network node for setting up a first call leg, the first signaling message including an identifier associated with the first call leg;
(b) receiving a second signaling message at the network node for setting up a second call leg, the second signaling message including an identifier associated with the second call leg; and
(c) determining whether the identifiers associated with the first and second call legs have a predetermined relationship with respect to each other, and in response to determining that the identifiers have a predetermined relationship with respect to each other, associating the first and second call legs with each other.

2. The method of claim 1 wherein the identifiers associated with the first and second call legs each include a call identifier value.

3. The method of claim 1 wherein the identifiers associated with the first and second call legs each include a loop counter.

4. The method of claim 1 wherein the identifiers associated with the first and second call legs each include a value identifying a bearer node associated with the respective call leg.

5. The method of claim 4 wherein the value identifying the bearer node includes an address of the bearer node.

6. The method of claim 5 wherein the address of the bearer node includes an Internet protocol (IP) address of the bearer node.

7. The method of claim 4 wherein at least one of the bearer nodes associated with the respective call legs comprises a media gateway.

8. The method of claim 1 wherein the identifier associated with the first call leg includes a value identifying the network node that sent the first signaling message, and the identifier associated with the second call leg includes a value identifying a network node that sent the second signaling message.

9. The method of claim 8 wherein the value identifying the network node that sent the respective signaling message includes an address of the network node that sent the respective signaling message.

10. The method of claim 9 wherein the address of the network node includes an Internet protocol (IP) address of the network node.

11. The method of claim 8 wherein at least one of the network nodes that sent the signaling messages comprises a media gateway controller.

12. The method of claim 1 wherein the identifiers comprise values stored in call association fields of the first and second signaling messages.

13. The method of claim 12 wherein the call association field of the first signaling message comprises a component of a session initiation protocol (SIP) loose routing header portion of the first signaling message.

14. The method of claim 12 wherein the call association field of the second signaling message comprises a component of a session initiation protocol (SIP) loose routing header portion of the second signaling message.

15. The method of claim 12 comprising copying, by a second network node, the identifier in the call association field of the first signaling message into the call association field of the second signaling message prior to sending the second signaling message to the network node.

16. The method of claim 15 wherein the second network node comprises an application server.

17. The method of claim 1 wherein the identifiers comprise bearer path origination and termination address information associated with the first and second call legs.

18. The method of claim 17 wherein the bearer path origination and termination address information is included in a session initiation protocol component of the first and second signaling messages.

19. The method of claim 17 wherein the bearer path origination and termination address information is included in a session description protocol component of the first and second signaling messages.

20. The method of claim 1 wherein step (c) comprises using one of the network node and a second network node to determine whether the identifiers associated with the first and second call legs have a predetermined relationship with respect to each other.

21. The method of claim 1 wherein step (c) comprises using one of the network node and a second network node to associate the first and second call legs with each other.

22. The method of claim 1 wherein the network node comprises one of a media gateway and a media gateway controller.

23. The method of claim 1 wherein step (c) comprises using a call manager to determine whether the identifiers associated with the first and second call legs have a predetermined relationship with respect to each other.

24. The method of claim 1 wherein step (c) comprises using call instances to determine whether the identifiers associated with the first and second call legs have a predetermined relationship with respect to each other.

25. The method of claim 1 wherein associating the first and second call legs together comprises using one of a database, a table, a storage location in memory, or other storage device.

26. The method of claim 1 wherein associating the first and second call legs with each other comprises:
(a) sending, by a call instance associated with the second call leg to a call instance associated with the first call leg, a message that includes the address information of the bearer path associated with the second call leg; and
(b) sending, by the call instance associated with the first call leg to the call instance associated with the second call leg, a response message that includes the address information of the bearer path associated with the first call leg.

27. A system for associating independent legs of a call, the system comprising:
(a) a network node adapted to send a first signaling message for setting up a first call leg, the first signaling message including an identifier associated with the first call leg, and the network node adapted to receive a second signaling message for setting up a second call leg, the second signaling message including an identifier associated with the second call leg; and
(b) a call association module adapted to determine whether the identifiers associated with the first and second call legs have a predetermined relationship with respect to each other, and in response to a determination that the identifiers have a predetermined relationship with respect to each other, associate the first and second call legs with each other.

28. The system of claim 27 wherein the identifiers associated with the first and second call legs each include a call identifier value.

29. The system of claim 27 wherein the identifiers associated with the first and second call legs each include a loop counter.

30. The system of claim 27 wherein the identifier associated with the first and second call legs each include a value identifying a bearer node associated with the respective call leg.

31. The system of claim 30 wherein the value identifying the bearer node includes an address of the bearer node.

32. The system of claim 31 wherein the address of the bearer node includes an Internet protocol (IP) address of the bearer node.

33. The system of claim 30 wherein at least one of the bearer nodes associated with the respective call legs comprises a media gateway.

34. The system of claim 27 wherein the identifier associated with the first call leg includes a value identifying the network node that sent the first signaling message, and the identifier associated with the second call leg includes a value identifying a network node that sent the second signaling message.

35. The system of claim 34 wherein the value identifying the network node that sent the respective signaling message includes an address of the network node that sent the respective signaling message.

36. The system of claim 35 wherein the address of the network node include Internet protocol (IP) address of the network node.

37. The system of claim 34 wherein at least one of the network nodes that sent the signaling messages comprises a media gateway controller.

38. The system of claim 27 wherein the identifiers comprise values stored in call association fields of the first and second signaling messages.

39. The system of claim 38 wherein the call association field of the first signaling message comprises a component of a session initiation protocol (SIP) loose routing header portion of the first signaling message.

40. The system of claim 38 wherein the call association field of the second signaling message comprises a component of a session initiation protocol (SIP) loose routing header portion of the second signaling message.

41. The system of claim 38 comprising a second network node adapted to receive the first signaling message, copy the identifier in the call association field of the first signaling message into the call association field of the second signaling message prior to sending the second message to the network node, and send the second signaling message to the network node.

42. The system of claim 41 wherein the second network node comprises an application server.

43. The system of claim 27 wherein the identifiers comprise bearer path origination and termination address information associated with the first and second call legs.

44. The system of claim 43 wherein the bearer path origination and termination address information is included in a session initiation protocol component of the first and second signaling messages.

45. The system of claim 43 wherein the bearer path origination and termination address information is included in a session description protocol component of the first and second signaling messages.

46. The system of claim 27 wherein the network node comprises one of a media gateway and a media gateway controller.

47. The system of claim 27 wherein the call association module comprises a component of the network node.

48. The system of claim 27 comprising a call manager adapted to manage call instances and to control the call association module.

49. The system of claim 27 comprising call instances associated with call legs and adapted to control the call association module in associating call legs with each other.

50. The system of claim 27 wherein the call association module is adapted to associate the first and second call legs together using one of a database, a table, a storage location in memory, or other storage device.

51. The system of claim 27 wherein the call association module includes first and second call instances respectively associated with the first and second call legs, wherein:
(a) the second call instance is adapted to send to the first call instance a message that includes the address information of the bearer path associated with the second call leg; and
(b) the first call instance is adapted to send to the second call instance a response message that includes the address information of the bearer path associated with the first call leg.

52. A call association initiating network element comprising:
(a) a signaling module for sending and receiving signaling messages containing identifiers respectively associated with independent call legs; and
(b) a call association module for analyzing the identifiers for determining whether any two or more of the identifiers have a predetermined relationship with respect to each other, and in response to determining that the two or more identifiers have a predetermined relationship, to associate the corresponding independent call legs with each other.

53. The call association initiating network element of claim 52 wherein the identifiers respectively associated with independent call legs each include a call identifier value.

54. The call association initiating network element of claim 52 wherein the identifiers respectively associated with independent call legs each include a loop counter.

55. The call association initiating network element of claim 52 wherein the identifiers respectively associated with independent call legs each include a value identifying a bearer node associated with the respective independent call leg.

56. The call association initiating network element of claim 55 wherein the value identifying the bearer node includes an address of the bearer node.

57. The call association initiating network element of claim 56 wherein the address of the bearer node includes an Internet protocol (IP) address of the bearer node.

58. The call association initiating network element of claim 52 wherein the identifiers respectively associated with independent call legs each include a value identifying a network node that sent the signaling message containing the respective identifier.

59. The call association initiating network element of claim 58 wherein the value identifying the network node includes an address of the network node.

60. The call association initiating network element of claim 59 wherein the address of the network node includes an Internet protocol (IP) address of the network node.

61. The call association initiating network element of claim 52 wherein the identifiers comprise values stored in call association fields of signaling messages respectively associated with the independent call legs.

62. The call association initiating network element of claim 61 wherein the call association field comprises a component of a session initiation protocol (SIP) loose routing header portion of the signaling messages.

63. The call association initiating network element of claim 52 wherein the identifiers comprise bearer path origination and termination address information associated with the respective independent call legs.

64. The call association initiating network element of claim 63 wherein the bearer path origination and termination address information is included in a session initiation protocol component of the signaling messages.

65. The call association initiating network element of claim 63 wherein the bearer path origination and termination address information is included in a session description protocol component of the signaling messages.

66. The call association initiating network element of claim 52 wherein the signaling module and the call association module are components of a media gateway.

67. The call association initiating network element of claim 52 wherein at least one of the independent call legs that are associated with each other is terminated by a media gateway.

68. The call association initiating network element of claim 52 comprising a call manager adapted to manage call instances and to control the call association module.

69. The call association initiating network element of claim 52 comprising call instances respectively associated with independent call legs and adapted to control the call association module in associating call legs with each other.

70. The call association initiating network element of claim 52 wherein the call association module is adapted to associate the corresponding independent legs with each other using one of a database, a table, a storage location in memory, or other storage device.

71. The call association initiating network element of claim 52 wherein the call association module includes first and second call instances respectively associated with the first and second call legs, wherein:
(a) the second call instance is adapted to send to the first call instance a message that includes the address information of the bearer path associated with the second call leg; and
(b) the first call instance is adapted to send to the second call instance a response message that includes the address information of the bearer path associated with the first call leg.

72. A computer program product comprising computer-executable instructions embodied in a computer-readable medium for performing steps comprising:
(a) sending a first signaling message from a network node for setting up a first call leg, the first signaling message including an identifier associated with the first call leg;
(b) receiving a second signaling message at the network node for setting up a second call leg, the second signaling message including an identifier associated with the second call leg; and
(c) determining whether the identifiers associated with the first and second call legs have a predetermined relationship with respect to each other, and in response to determining that the identifiers have a predetermined relationship with respect to each other, associating the first and second call legs with each other.

73. The computer program product of claim 72 wherein the identifiers comprise values stored in call association fields of the first and second signaling messages.

74. The computer program product of claim 72 wherein the identifiers comprise bearer path origination and termination address information associated with the first and second call legs.
